(19) United States
(12) Patent Application Publication
(10) Pub. No.: US 2020/0199023 A1
(43) Pub. Date: Jun. 25, 2020

(54) PREPARATION OF POZZOLANIC MATERIAL-CONTAINING AMPHOTERIC COMPOSITE HYDROGEL AND USE THEREOF

(71) Applicant: NATIONAL TAIWAN NORMAL UNIVERSITY, Taipei City (TW)

(72) Inventors: Jin-Liang Lin, Taipei City (TW); Xin-Yi Liu, Taipei City (TW); Kung-Chung Hsu, Taipei City (TW)

(21) Appl. No.: 16/360,064

(22) Filed: Mar. 21, 2019

(30) Foreign Application Priority Data
Dec. 22, 2018 (TW) 107146639

(51) Int. Cl. C04B 26/06; C04B 28/18; C08L 33/14; C08F 20/38; C08F 220/56; C08K 5/20

(52) U.S. Cl. CPC C04B 26/06; C04B 28/18; C08L 33/14; C04B 2103/445; C08F 220/56; C08K 5/20; C08F 20/38

(57) ABSTRACT

Provided is an amphoteric composite hydrogel, including: a polymer having a structure of formula I,

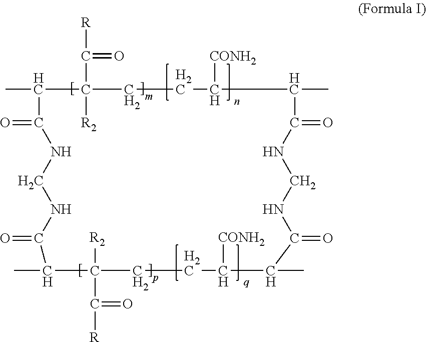

wherein m, n, p and q are each an integer of 0 to 1000, m+n>100, p+q>100, R is

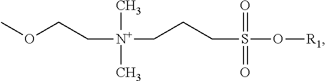

R₁ is H or an alkali metal element, and R₂ is H or CH₃; and a pozzolanic material incorporated into the structure of formula 1. Also provided are a cement mortar composition and a concrete composition each comprising the amphoteric composite hydrogel and a method of preparing the amphoteric composite hydrogel.

### BACKGROUND

### Technical Field

The present disclosure relates to amphoteric composite hydrogels and preparation methods thereof, and specifically to a cement mortar composition and a concrete composition comprising an amphoteric composite hydrogel.

### Description of Related Art

Water-absorbent materials, such as health care products and desiccants, are closely related to modern life. In the past, the raw materials used as water-absorbent materials are usually taken from natural materials or those simply processed. However, since these materials only keep water in the gaps of materials by the capillary principle, the water absorbency capacity is poor and water is lost immediately after being pressurized, and thereby being very limited in use.

In 1961, Russel and Fanta of the United States made starch graft acrylonitrile to prepare materials with excellent water absorbency after hydrolysis, which can absorb water of hundreds to thousands of times of their own weight, and have good water retention capacity, without losing water even under pressure. These materials, after fully absorbing water and then drying, can restore the water absorbency for reuse. Accordingly, these materials are called superabsorbent polymers or hydrogels.

Water-absorbing hydrogel is a polymer with 3D reticular structure, and the main reason for absorbing such a large amount of water is the crosslinking density of its structure and the unique functional groups on the molecular chain. The hydrogel itself contains a large amount of hydrophilic functional groups such as —COONa and —CONH₂, and the hydrophilic functional groups on the polymer chain are dissociated upon contacting water. For example, when —COONa dissociated in water becomes —COO⁻, it can hydrate with water molecules in water to capture water, and allows the 3D reticular structure to be expanded by the electrostatic repulsion between the negative and negative charges on the functional group, facilitating penetration of water. Since the hydrogel has a reticular structure, the structure is only expanded after the water molecules enter, and made the hydrogel moisturized, not dissolved.

Concrete is the most widely used civil engineering material for architectural and structural engineering. The newly placed concrete will be affected by the external environment, such as temperature, humidity and wind, causing water in the concrete to evaporate outside or be lost. Consequently, drying shrinkage of the concrete would occur, resulting in cracks and loose structures, leading to poor quality in construction. Therefore, after completion of placing the concrete, curing is required. Curing is to replenish concrete with water or prevent loss of water. The purpose is to allow the hydration of cement to continue, and thereby preventing drying shrinkage and cracking of concrete, which cause the decrease in durability and strength of the concrete, from occurring.

Owing to the good water absorbency property, a hydrogel is used as an internal curing agent or a self-curing agent. Since hydrogels can release water adsorbed therein, adding hydrogels to mortar or concrete can keep more water inside concrete and maintain higher humidity. The cement hydrate is thus more complete, and drying shrinkage and cracks are less likely to occur in concrete. Accordingly, the durability of concrete is improved, and the maintenance frequency of concrete structures is reduced.

Polyacrylate (PAA) or poly(acrylate-co-acrylamide) (P(AA/AM)) are hydrogels commonly used as concrete self-curing agent in engineering. Despite of good effect, there is a need for improvement. For example, the water absorbency of hydrogel in brine is much lower than that in pure water; and the strength of hydrogels is less than cement and aggregates, so that the strength of harden concrete added with hydrogels is often lower than those without adding hydrogels. Therefore, developing a composite hydrogel having excellent water absorbency and high strength is necessary.

### SUMMARY

The present disclosure provides an amphoteric composite hydrogel, comprising: a polymer having a structure of formula I,

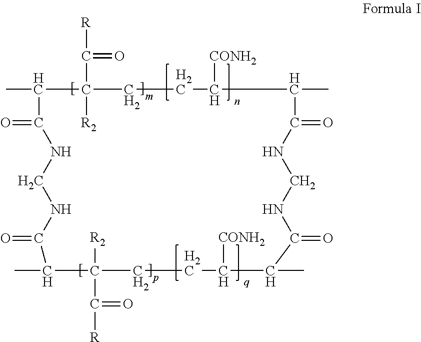

wherein m, n, p and q are each an integer of 0 to 1000, m+n>100, p+q>100, R is

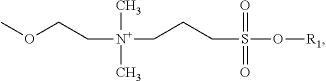

R₁ is H or an alkali metal element, and R₂ is H or CH₃; and a pozzolanic material incorporated into the polymer having the structure of formula I.

The present disclosure further provides a cement mortar composition, comprising: a mortar mix, and the amphoteric composite hydrogel of the present disclosure.

The present disclosure further provides a concrete composition comprising a concrete mix, and the amphoteric composite hydrogel of the present disclosure.

Accordingly, the amphoteric composite hydrogel provided by the present disclosure can be added to the cement mortar composition and used as a curing agent for the concrete composition, so as to maintain the humidity in the concrete or cement mortar.

### BRIEF DESCRIPTIONS OF THE DRAWINGS

FIG. 1 shows an IR spectrum of amphoteric composite hydrogel P12 of the present disclosure, and amphoteric hydrogel P0 in the comparative example;

FIG. 2 shows a scanning electron microscope (SEM) photograph of amphoteric composite hydrogel P11 of the present disclosure;

FIG. 3 shows the water absorbency of amphoteric composite hydrogels P11 to P13 of the present disclosure and amphoteric hydrogel P0 in the comparative example in deionized water;

FIG. 4 shows a graph showing the influence of the slag content of the present disclosure on the saturated water absorbency of the amphoteric composite hydrogel in deionized water and in a pore solution;

FIG. 5 shows a graph showing the influence of the amphoteric composite hydrogel containing the slag of the present disclosure on the internal humidity of the cement mortar;

FIG. 6 shows a graph showing the influence of the amphoteric composite hydrogel containing the slag of the present disclosure on the compressive strength of the cement mortar;

FIG. 7 shows a graph showing the influence of the amphoteric composite hydrogel containing silica fume or fly ash on the compressive strength of the cement mortar;

FIG. 8 shows a graph showing the influence of the amphoteric composite hydrogel containing the slag of the present disclosure on the drying shrinkage of the cement mortar;

FIG. 9 shows a graph showing the influence of the amphoteric composite hydrogel containing the slag of the present disclosure on the autogenous shrinkage of the cement mortar;

FIG. 10 shows the effect of the amphoteric composite hydrogel containing silica fume or fly ash on the autogenous shrinkage of the cement mortar; and

FIG. 11 shows a differential scanning calorimetry (DSC) diagram of a cement paste to which the slag-containing amphoteric composite hydrogel of the present disclosure and the amphoteric hydrogel in the comparative example are added.

### DETAILED DESCRIPTION OF THE EMBODIMENTS

The implementation of the present disclosure is described by referring to the following embodiments, and those skilled in the art can readily understand the advantages and effects of the present disclosure. The present disclosure may be implemented or applied through other embodiments. The various details of the present disclosure may be variously modified and altered without departing from the spirit and scope of the present disclosure. In addition, all of the ranges and values disclosed herein are inclusive and combinable. Any numerical value or point fallen within the ranges disclosed herein, such as any integer, may be used as a minimum or maximum value to derive a lower range, etc.

The present disclosure provides an amphoteric composite hydrogel, comprising:

a polymer having the structure of formula I,

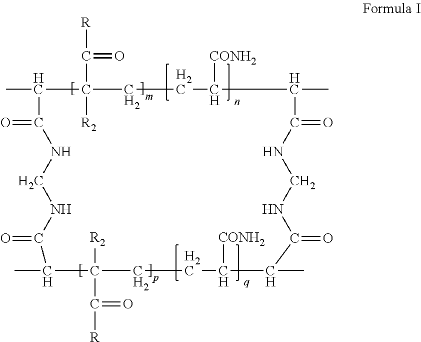

wherein m, n, p and q are each an integer of 0 to 1000, m+n>100, p+q>100, R is

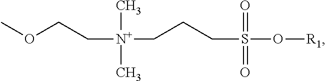

and R₁ is H or an alkali metal element; and R₂ is H or CH₃; and

a pozzolanic material being incorporated into the polymer having the structure of formula I.

In an embodiment of the present disclosure, the pozzolanic material is at least one selected from the group consisting of slag (SG), fly ash (FA), silica fume (SF), rice husk ash, kaolin, montmorillonite and diatomite.

In an embodiment of the present disclosure, the pozzolanic material is at least one selected from the group consisting of slag (SG), fly ash (FA) and silica fume (SF).

The slag is a by-product obtained in the process of steel smelting; the fly ash is the waste produced by coal-fired power plants after burning pulverized coal; and the silica fume is a by-product obtained in the smelting process of silicon metal. The application of a pozzolanic material in a cementitious composite material mainly provides two types of effect, including the pozzolanic effect and filling effect. Since the pozzolanic material can be reacted with calcium hydroxide (Ca(OH)₂, CH) in the cement hydration product to form a calcium silicate hydrate (abbreviated as “CSH gel”), it can reinforce the bonding force of the aggregate interface. In addition, the reaction between the pozzolanic material and the calcium hydroxide can accelerate the hydration rate of the cement, and thereby increasing the strength of the material. Generally, the powder size of the applied pozzolanic material is smaller than that of the cement. Therefore, the pozzolanic material is filled between the aggregates, such that the porosity is reduced and the compactness of the concrete is increased.

In an embodiment of the present disclosure, the pozzolanic material is 0.1 to 40 wt %, based on the polymer; preferably, the pozzolanic material is from 1 to 20 wt %, based on the polymer.

In an embodiment, it is found in the present disclosure that the content of the pozzolanic material has an influence on the saturated water absorbency of the amphoteric composite hydrogel. When the pozzolanic material is about 10 wt %, the hydrogel has the maximum water absorbency. When the pozzolanic material is more than 10 wt %, the gel content in the composite hydrogel decreases with the increase in the content of the pozzolanic material. As such, the reticular space of the amphoteric composite hydrogel decreases, and thereby decreasing the water absorbency.

In an embodiment, the amphoteric composite hydrogel of the present disclosure has saturated water absorbency of 50 g/g to 70 g/g in a pore solution of a cement paste having a water-cement ratio of 0.485.

According to the foregoing description, the present disclosure provides a method for preparing an amphoteric composite hydrogel, comprising the steps of: polymerizing at least one an acrylate/acrylamide-based monomer and an amphoteric monomer; and adding a pozzolanic material for copolymerization to form an amphoteric composite hydrogel having a pozzolanic material incorporated into the structure of formula I:

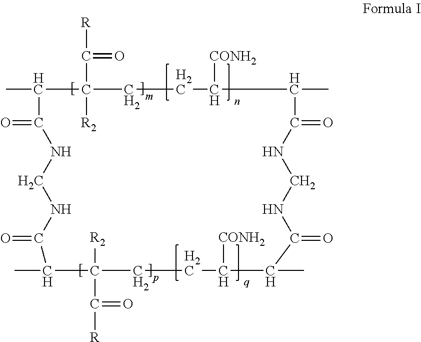

wherein m, n, p and q are each an integer of 0 to 1000, m+n>100, p+q>100, R is

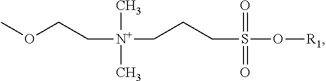

and R₁ is H or an alkali metal element; and R₂ is H or CH₃.

In an embodiment of the present disclosure, the acrylate/acrylamide-based monomer is acrylamide (AM). The amphoteric monomer is [2-(methacryloyloxy)ethyl]dimethyl-(3-sulfopropyl)-ammonium hydroxide (ME). In an embodiment of the present disclosure, the pozzolanic material is 0.1 to 40 wt %, based on the polymer; preferably, the pozzolanic material is 1 to 20 wt %, based on the polymer.

The present disclosure further provides a method of preparing a P(AM/ME)/pozzolanic material amphoteric composite hydrogel, comprising the steps of: subjecting an acrylamide (AM) and [2-(methacryloyloxy)ethyl]dimethyl-(3-sulfopropyl)ammonium hydroxide (ME) to copolymerization; and then adding a pozzolanic material for copolymerization, wherein the pozzolanic material is at least one selected from the group consisting of slag (SG), fly ash (FA), silica fume (SF), rice husk ash, kaolin, montmorillonite and diatomite to form a P(AM/ME)/pozzolanic material amphoteric composite hydrogel.

In an embodiment, the pozzolanic material is at least one selected from the group consisting of slag (SG), silica fume (SF) and fly ash (FA).

In an embodiment, the amphoteric composite hydrogel of the present disclosure has solid powder having a particle size of 0.05 mm to 0.25 mm, and can be solid powder having a particle size of 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24 or 0.25 mm. In an embodiment, the smaller the particle size of the amphoteric composite hydrogel of the present disclosure is, the greater the compressive strength is.

According to the foregoing description, the present disclosure provides a cement mortar composition, comprising: a mortar mix, and an amphoteric composite hydrogel comprising a polymer having the structure of formula I:

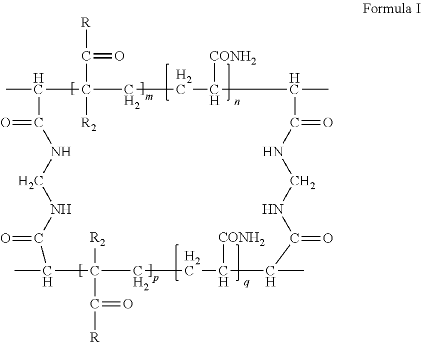

wherein m, n, p and q are each an integer of 0 to 1000, m+n>100, p+q>100, R is

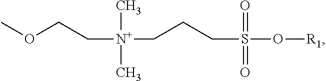

and R₁ is H or an alkali metal element; and R₂ is H or CH₃; and the amphoteric composite hydrogel includes a pozzolanic material being incorporated into the polymer having the structure of formula I.

In an embodiment of the cement mortar composition of the present disclosure, the mortar mix comprises water, cement, fine aggregates and a dispersant.

In an embodiment of the cement mortar composition of the present disclosure, the amphoteric composite hydrogel is 0.1 to 0.5 wt %, based on the cement.

In the cement mortar composition, fine aggregates are granular materials such as sand, or crushed stone passing through a No. 4 sieve according to the ASTM C33 standard, and the particle size is from 150 μm to 4.75 mm.

In an embodiment, the dispersant is an anionic dispersant.

According to the foregoing description, the present disclosure provides a concrete composition, comprising: a concrete mix, and an amphoteric composite hydrogel comprising a polymer having the structure of formula I:

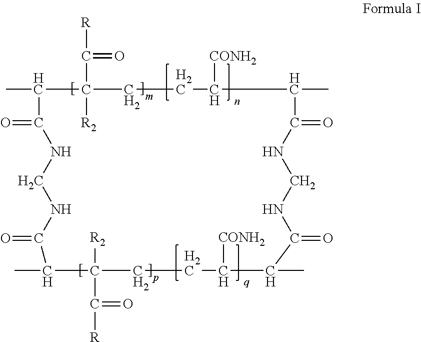

wherein m, n, p and q are each an integer of 0 to 1000, m+n>100, p+q>100, R is

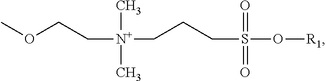

and R₁ is H or an alkali metal element; and R₂ is H or CH₃; and the amphoteric composite hydrogel comprises a pozzolanic material being incorporated into the polymer having the structure of formula I.

In an embodiment of the concrete composition of the present disclosure, the concrete mix comprises water, cement, fine aggregates and coarse aggregates; wherein the concrete mix further comprises a material such as fly ash, slag, and silica fume.

In an embodiment of the concrete composition of the present disclosure, the amphoteric composite hydrogel is 0.1 to 5 wt %, based on the cement.

In the concrete composition, coarse aggregates are particles such as gravel, or crushed stone remaining on No. 4 sieve according to the ASTM C33 standard, and the particle size is greater than 4.75 mm.

In the concrete composition, fine aggregates are granular materials such as sand, or crushed stone passing through No. 4 sieve according to the ASTM C33 standard, and the particle size is from 150 μm to 4.75 mm.

The present disclosure relates to the preparation of an amphoteric composite hydrogel, and the novel amphoteric composite hydrogel is used as an internal curing agent. In the brine, the P(AM/ME)/pozzolanic material amphoteric composite hydrogel of the present disclosure has higher water absorbency than the P(AA/AM) hydrogel free of the pozzolanic material. When adding cementitious materials such as cement mortar or concrete, the compressive strength of the material can be increased, and the drying shrinkage and autogenous shrinkage of the material can be reduced. Therefore, the amphoteric composite hydrogel of the present disclosure is indeed a concrete self-curing agent with superior performance.

The examples of the present disclosure are only intended to exemplify the embodiments thereof, and are not intended to limit the present disclosure.

### Example 1: Synthesis of P(AM/ME)/SG Amphoteric Composite Hydrogel Containing 5 wt % of SG

0.43 g of slag (SG) (purchased from Taiwan Plastics Co., Ltd.) was weighed and soaked in 20 mL of deionized water. Also, 0.01 g of A301 dispersant (an anionic dispersant, purchased from Xin De Enterprise Co., Ltd.) was added, and the mixture was stirred for 20 minutes. Then, after taking and dissolving 4.3 g of acrylamide (AM) and 4.2 g of [2-(methacryloyloxy)ethyl]dimethyl-(3-sulfopropyl)ammonium hydroxide (ME) in 40 mL of of deionized water, the mixture was placed in a four-necked reaction flask, and the reaction temperature was adjusted to 65° C. The above-prepared slag dispersion was added, and 0.24 g of N,N′-methylenebisacrylamide (MBA) as a crosslinking agent and 0.087 g of ammonium persulfate (APS) as an initiator were gradually added. The mixture was continuously reacted for 3 hours, until the solution became a colloidal state. The product was purified with an appropriate amount of methanol, and soaked in a large amount of deionized water, of which the same volume was changed twice a day to remove the remaining monomers. After 3 days, a sample was taken out and placed into an oven at 65° C. for 48 hours to obtain a gray solid amphoteric composite hydrogel containing slag (SG), written as P(AM/ME)/SG, with a yield of more than 70%. In addition, the slag (SG) was 5 wt %, based on the polymeric amphoteric composite hydrogel.

The solid amphoteric composite hydrogel was ground and sieved by a ball mill to obtain amphoteric composite hydrogel P11 having a particle size of 0.21 mm to 0.25 mm (60 mesh to 70 mesh).

P11: P(AM/ME)/SG amphoteric composite hydrogel containing 5 wt % of SG

### Example 2: Synthesis of P(AM/ME)/SG Amphoteric Composite Hydrogel Containing 10 to 20 wt % of SG

A P(AM/ME)/SG amphoteric composite hydrogel was prepared according to the method of Example 1, except that the content of SG was changed to prepare P12 and P13, i.e., P(AM/ME)/SG amphoteric composite hydrogels containing different SG contents:

P12: P(AM/ME)/SG amphoteric composite hydrogel containing 10 wt % of SG

P13: P(AM/ME)/SG amphoteric composite hydrogel containing 20 wt % of SG

### Example 3: Synthesis of P(AM/ME)/SF Amphoteric Composite Hydrogel Containing 10 to 20 wt % of SF

A P(AM/ME)/SF amphoteric composite hydrogel was prepared according to the method of Example 2, except that SG was changed to silica fume (SF, purchased from Sika Taiwan Ltd.) to prepare P22 and P23, i.e., P(AM/ME)/SF amphoteric composite hydrogels containing different SF contents:

P22: P(AM/ME)/SF amphoteric composite hydrogel containing 10 wt % of SF

P23: P(AM/ME)/SF amphoteric composite hydrogel containing 20 wt % of SF

### Example 4: Synthesis of P(AM/ME)/FA Amphoteric Composite Hydrogel Containing 10 to 20 wt % of FA

A P(AM/ME)/FA amphoteric composite hydrogel was prepared according to the method of Example 2, except that SG was changed into fly ash (FA, purchased from Taiwan Plastics Co., Ltd.) to prepare P32 and P33, i.e., P(AM/ME)/FA amphoteric composite hydrogels containing different FA contents:

P32: P(AM/ME)/FA amphoteric composite hydrogel containing 10 wt % of FA

P33: P(AM/ME)/FA amphoteric composite hydrogel containing 20 wt % of FA

### Comparative Example 1: Synthesis of P(AA/AM) Hydrogel

8.7 g of acrylic acid (AA) and 2.1 g of acrylamide (AM) were weighed and dissolved in 110 mL of deionized water, and the mixture was placed in a four-necked reactor. The reaction temperature was slowly rising to 70° C., and 0.14 g of APS as an initiator and 0.07 g of MBA as a crosslinking agent were added dropwise, and the reaction was continued for 2 hours until the solution became a colloidal state. The product was purified with an appropriate amount of methanol, and soaked in a large amount of deionized water, of which the same volume was changed twice a day to remove the unreacted monomers. After 3 days, a sample was taken out and placed into an oven at 65° C. for 2 days to obtain a transparent dry solid hydrogel P(AA/AM), with a yield of more than 80%.

The solid hydrogel was ground by a ball mill to obtain hydrogel R0 having a particle size of 0.21 mm to 0.25 mm (60 mesh to 70 mesh).

R0:P(AA/AM) hydrogel

### Comparative Example 2: Synthesis of P(AM/ME) Amphoteric Hydrogel without a Pozzolanic Material

4.3 g of acrylamide (AM) and 4.2 g of [2-(methacryloyloxy)ethyl]dimethyl-(3-sulfopropyl)ammonium hydroxide (ME) were weighed and dissolved in 60 mL of deionized water. Then, the mixture was placed in a four-necked reaction flask. The reaction temperature was adjsuted to 65° C., and 0.24 g of MBA as a crosslinking agent and 0.087 g of APS as an initiator were gradually added, and the reaction continued for 3 hours until the solution became a colloidal state. The product was purified with an appropriate amount of methanol, and soaked in a large amount of deionized water, of which the same volume was changed twice a day to remove the remaining monomers. After 3 days, a sample was taken out and placed into an oven at 65° C. for 48 hours to obtain a transparent solid hydrogel P(AM/ME), with a yield of more than 70%.

The solid amphoteric hydrogel was ground and sieved using a ball mill to obtain amphoteric hydrogel P0 having a particle size of 0.21 mm to 0.25 mm (60 mesh to 70 mesh).

P0:P(AM/ME) amphoteric hydrogel

### Preparation Example 1: Preparation of Cement Mortar

A cement mortar having a water-cement ratio (W/C) of 0.485 was mixed according to the ASTM C305 specification. 242.5 g of water, 500 g of cement (Portland Type I cement purchased from Taiwan Cement Company), A301 dispersant (0.1 wt % of cement, purchased from Xin De Enterprise Co., Ltd.), 1375 g of fine sand (Ottawa sand) were mixed with each of the hydrogels obtained in the above examples and comparative examples to form cement mortars. Table 1 shows the types and proportions of each hydrogel added in the cement mortar (=hydrogel/cement weight ratio).

The fresh mortar was controlled to a certain degree of fluidity (205 to 215 mm). The fluidity value was based on the ASTM C1437 specification, and the mixed cement mortar was poured into a truncated cone, and after tamping, the cone was smoothed, and the truncated cone was picked up to vibrate the mortar on the vibration table. The measurement was taken after 25 times of vibration in 15 seconds.

TABLE 1

| | Hydrogel | Hydrogel |
|---|---|---|
| Sample | type | content |
| M0 | — | 0 wt % |
| M3 | P0 | 0.2 wt % |
| M311 | P11 | 0.2 wt % |
| M312 | P12 | 0.2 wt % |
| M313 | P13 | 0.2 wt % |
| M322 | P22 | 0.2 wt % |
| M323 | P23 | 0.2 wt % |
| M332 | P32 | 0.2 wt % |
| M333 | P33 | 0.2 wt % |

### Preparation Example 2: Preparation of Cement Paste

A cement paste having a water-cement ratio (W/C) of 0.3 was mixed, the cement used was Portland Type I cement purchased from Taiwan Cement Company, and the amphoteric composite hydrogel of the present disclosure was added to the cement paste. Table 2 shows the types and proportions of each hydrogel added into the cement paste (=hydrogel/cement weight ratio).

TABLE 2

| | Hydrogel | Hydrogel |
|---|---|---|
| Sample | type | content |
| C0 | — | 0 wt % |
| C3 | P0 | 0.2 wt % |
| C311 | P11 | 0.2 wt % |
| C312 | P12 | 0.2 wt % |
| C313 | P13 | 0.2 wt % |

### Preparation Example 3: Preparation of Pore Solution of Cement Paste

Two cement pastes with a water-cement ratio (W/C)=0.485 were mixed. The cement used was the Portland type I cement purchased from Taiwan Cement company. One of the cement pastes was stirred for 5 minutes to obtain pore solution 1 by suction filtration; the other cement paste was stirred for 60 minutes to obtain pore solution 2 by suction filtration.

### Test Example 1: An Analysis by Infrared (IR) Spectroscopy

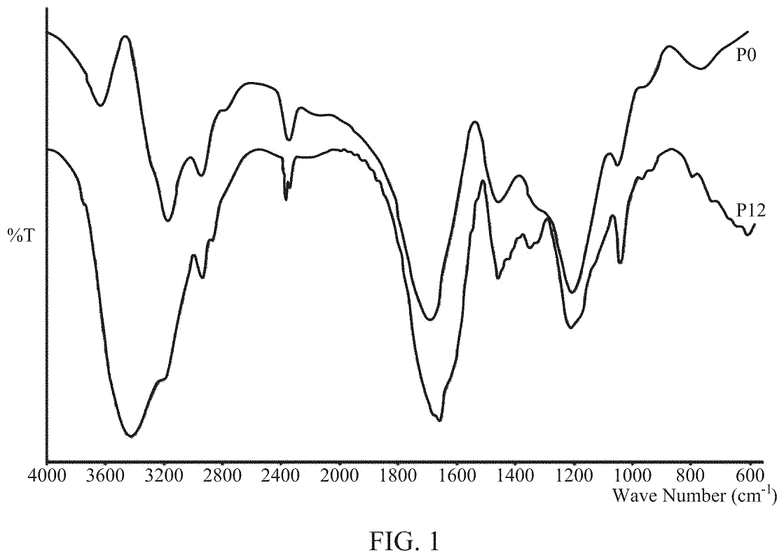

Appropriate samples of amphoteric hydrogel P0 and amphoteric composite hydrogel P12 were taken out for measurement of the IR spectrum using an IR spectrometer (Perkin Elmer Paragon 500 FT-IR) as shown in FIG. 1. The IR spectrum of P0 had absorbency peaks at wave numbers of 3631, 3175, 1688, 1449, 1195, and 1044 cm⁻¹, respectively. The IR spectrum of P12 had absorbency peaks at wave numbers of 3426, 1658, 1458, 1210, 1040, 799, and 605 cm⁻¹, respectively.

### Test Example 2: The Micro-Structure of an Amphoteric Composite Hydrogel

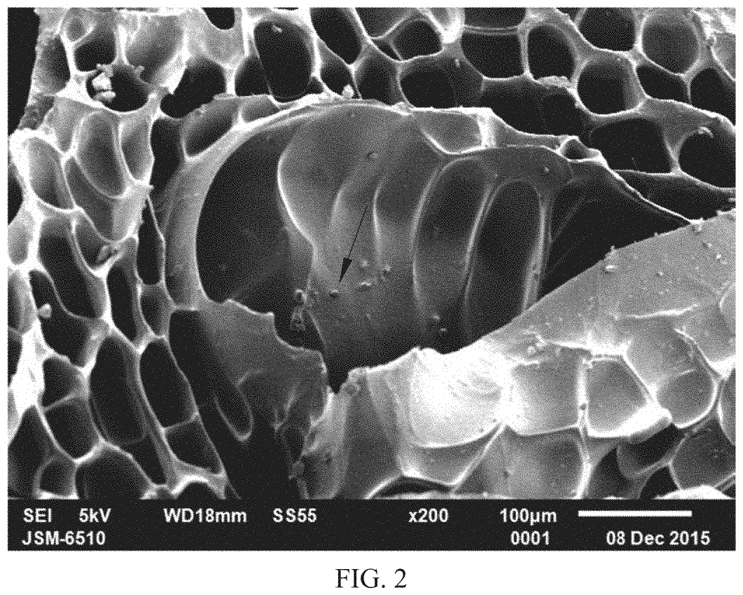

A scanning electron microscope (JSM-6510, JEOL) was used to obtain an SEM photograph of an appropriate amount of amphoteric composite hydrogel P11 after absorbing water. As shown in FIG. 2, the slag particles were embedded in the structure of amphoteric composite hydrogel P11 containing pores.

### Test Example 3: Hydrogel Water Absorbency

0.1 g to 0.15 g of dry hydrogels P(AA/AM) (W_{dry}), P(AM/ME) (W_{dry}), P(AM/ME)/SG (W_{dry}), P(AM/ME)/SF(W_{dry}) and P(AM/ME)/FA (W_{dry}) were each placed in a tea bag, and the tea bags were soaked in the test solution. An empty tea bag without hydrogel weighed Wₜ after absorbing water, and the tea bags with hydrogel weighed W_{wet} after absorbing water. The water absorbency Q(g/g) of hydrogel was then obtained, as shown in the following formula II:

$$Q = \frac{{W}_{wet} - {W}_{dry} - {W}_{t}}{{W}_{dry}} \qquad Formula II$$

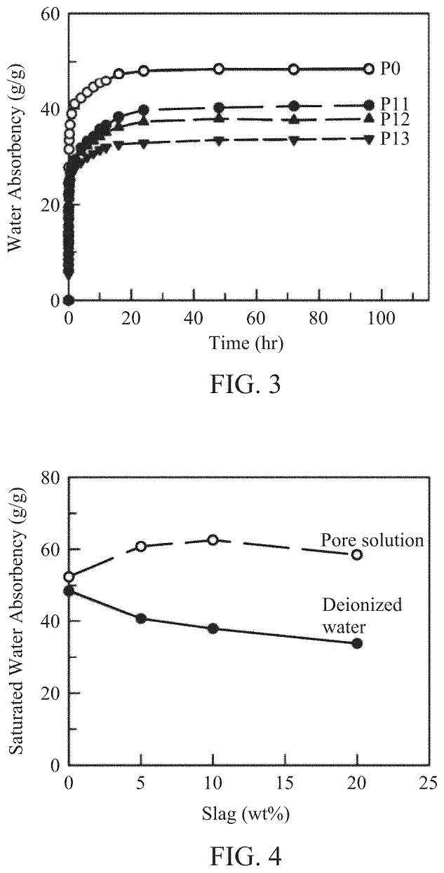

With reference to FIG. 3 for the water absorbency of amphoteric hydrogel P0 and amphoteric composite hydrogels P11 to P13 containing the slag in deionized water, the water absorbency of each the hydrogels firstly increases with the soaking time, and gradually reaches a plateau. The maximum value is the saturated water absorbency. The saturated water absorbency per gram of amphoteric hydrogel P0 in deionized water is about 48 grams. The saturated water absorbency of each of amphoteric composite hydrogels P11 to P13 with slag added in deionized water is lower than that of the hydrogel P0 without slag.

FIG. 4 shows the saturated water absorbency of amphoteric hydrogel P0 and amphoteric composite hydrogels P11 to P13 containing the slag in an artificially simulated pore solution. The artificially simulated pore solution was formed by dissolving 0.4 mole of NaOH, 0.08 mole of K₂SO₄, 0.32 mole of KOH, and 0.001 mole of Ca(OH)₂ in water to obtain 1 L of a pore solution. As shown in the figure, the saturated water absorbency of each amphoteric hydrogel P0 and amphoteric composite hydrogels P11 to P13 is higher in the pore solution than in deionized water. In addition, as the proportion of the added slag increases, the saturated water absorbency of the hydrogel increases, and then decreases after reaching the maximum. Although the water absorbency of each of amphoteric composite hydrogels P11 to P13 is lower than that of the amphoteric hydrogel P0 in deionized water, the water absorbency of amphoteric composite hydrogels P11 to P13 is higher than that of the amphoteric hydrogel P0 in the artificial simulated pore solution. The P(AM/ME)/pozzolanic material amphoteric composite hydrogel is shown to be less affected by the ions and ionic concentrations in the pore solution.

Table 3 below shows the saturated water absorbency of hydrogel R0, amphoteric hydrogel P0, and amphoteric composite hydrogels P11, P12, P13, P22, P23, P32, P33 with added slag, silica fume or fly ash in deionized water, pore solution 1 and pore solution 2 of Preparation example 3. The table shows that saturated water absorbency of hydrogel R0 in different solutions was: deionized water>pore solution 1>pore solution 2; and the saturated water absorbency of amphoteric hydrogel P0 in different solutions was: pore solution 1>pore solution 2>deionized water.

The cement mainly contains four types of mineral components: C₃S (tricalcium silicate), C₂S (dicalcium silicate), C₃A (tricalcium aluminate), and C₄AF (tetracalcium aluminoferrite). When the cement is exposed to water, various ions are released into water and react to form hydrates. Consequently, the pore solution in the cement paste becomes a brine containing various ions such as Na⁺, K⁺, Ca²⁺, OH⁻ and SO₄²⁻ in a short time, and the ion concentration of the pore solution increases with the increasing contact time. Thus, the ion concentration of pore solution 2 is higher than that of pore solution 1. As the concentration of the brine ions increases, the osmotic pressure difference between the inside and outside of the gel decreases. As a result, the water absorbency of hydrogel R0 soaked in the brine decreases. By contrast, amphoteric hydrogel P0 produces an anti-polyelectrolyte effect in the brine solution, such that the water absorbency of the amphoteric hydrogel in the brine solution is higher than in deionized water. Therefore, the water absorbency of amphoteric hydrogel P0 is higher in pore solution 1 than in deionized water. Although the water absorbency of the amphoteric hydrogel P0 is lower in pore solution 2 than in pore solution 1, the decrease is lower than that of the hydrogel R₀. It shows that P(AM/ME) amphoteric hydrogel has better salt-tolerant property than P(AA/AM) hydrogel.

The results in Table 3 also show that the saturated water absorbency of each of the amphoteric composite hydrogels containing slag, silica fume or fly ash is higher in pore solution 1 and pore solution 2 than in deionized water. The saturated water absorbency of each of the amphoteric composite hydrogels containing slag, silica fume or fly ash is higher in pore solution 1 and pore solution 2 than that of amphoteric hydrogel P0. It shows that the addition of slag, silica fume or fly ash in an amphoteric hydrogel would increase the saturated water absorbency of the amphoteric hydrogel. In addition, as the proportion of the added slag, silica fume, or fly ash increases, the saturated water absorbency of the hydrogel increases, and then decreases after reaching a maximum at an addition proportion of 10%.

TABLE 3

| | | Pore | Pore |
|---|---|---|---|
| Hydrogel | Deionized | solution 1 | solution 2 |
| type | water | (5 min) | (2 hr) |
| R0 | 581 | 49.2 | 45.3 |
| P0 | 50.1 | 54.0 | 50.2 |
| P11 | 41.2 | 56.4 | 54.1 |
| P12 | 38.2 | 59.3 | 57.3 |
| P13 | 34.3 | 54.6 | 53.4 |
| P22 | 45.1 | 69.8 | 63.1 |
| P23 | 43.6 | 62.8 | 57.1 |
| P32 | 40.3 | 69.2 | 60.3 |
| P33 | 39.6 | 58.8 | 55.3 |

### Test Example 4: Internal Humidity of Cement Mortar

The cement mortar sample of the above Preparation example 1 was filled into a mold to prepare a sample of 5×5×5 cm³. After 10 minutes, the humidity probe was inserted into the sample to a depth of 2.5 cm. After standing for one day in the laboratory, the mold was removed and placed in a constant temperature and humidity chamber (25° C., 50 RH %) for curing. With a humidity sensor/analyzer (RIXEN 760MTD), the measurement of the internal humidity of the cement mortar sample at different times was taken.

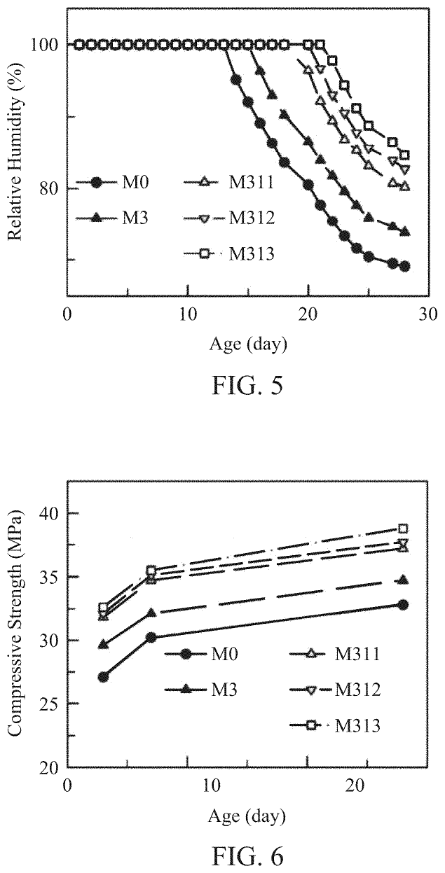

With reference to FIG. 5, the internal humidity of each of sample MO without hydrogel, sample M3 using the amphoteric hydrogel, and samples M311 to M313 using the amphoteric composite hydrogel is shown. The initial internal humidity is 100%, and after 13 days, the internal humidity gradually decreases with the curing time. The internal humidity of the sample with added the amphoteric hydrogel or the amphoteric composite hydrogel decreases later, and the humidity is higher than that of sample MO to which no hydrogel is added. The humidity of M311 to M313, after 15 days, is higher than that of M3 cement mortar of amphoteric hydrogel P0 which is not added with slag.

The amphoteric composite hydrogel of the present disclosure can release water adsorbed therein, so that the interior of the cement mortar sample can maintain higher humidity. The water absorbency of the amphoteric composite hydrogel containing the pozzolanic material in the pore solution is higher than that of the amphoteric hydrogel containing no pozzolanic material, and thus the amphoteric composite hydrogel containing the pozzolanic material could release more adsorbed water accordingly.

### Test Example 5: Compressive Strength of Cement Mortar

The cement mortar sample (5×5×5 cm³) prepared in the above Test example 4 was placed in a constant temperature and humidity chamber at a temperature of 25±2° C. and a humidity of 50±5%. According to the ASTM C109 standard, a compression test machine (Hongda HT-9501) test was taken, and the compressive strength of the samples on Day 3, 7 and 28 were recorded.

FIG. 6 shows the effect of the type of amphoteric composite hydrogel containing slag on the compressive strength of cement mortar. The results show that the compressive strength of samples M311 to M313 with the addition of the amphoteric composite hydrogel is higher than that of the sample MO without the hydrogel on Day 3, 7, and 28. The compressive strength of cement mortars M311 to M313 containing the amphoteric composite hydrogel with added slag is also higher than that of cement mortar M3 without the addition of slag. The reason is that the strength of the amphoteric composite hydrogel containing slag is higher than that of the hydrogel free of slag; and the slag in the amphoteric composite hydrogel and the infiltrated pore solution are subject to a pozzolanic reaction to increase the amount of CSH gel in the sample. Therefore, the mortar sample of the amphoteric composite hydrogel containing slag has a higher compressive strength.

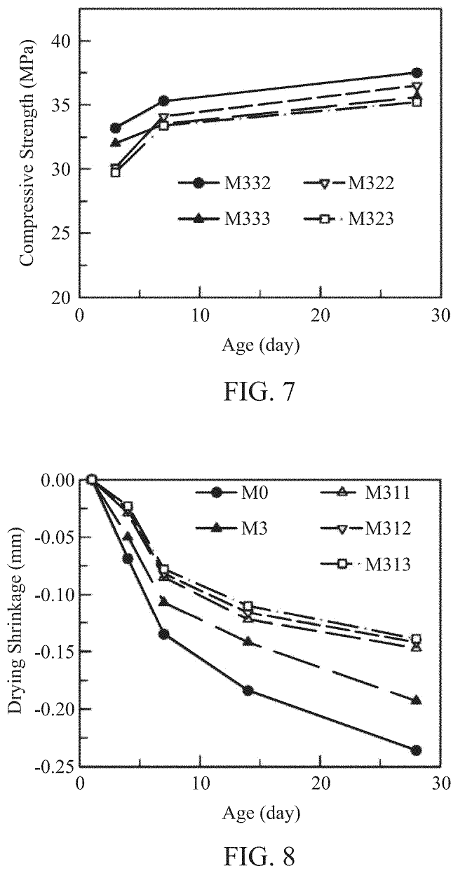

FIG. 7 shows the effect from the amphoteric composite hydrogel type containing silica fume or fly ash on the compressive strength of cement mortar. From the results of FIGS. 6 and 7, the compressive strengths of the samples M322 to M323 added with the amphoteric composite hydrogel containing the silica fume on Days 3, 7, and 28 are higher than sample MO without adding the hydrogel. The compressive strength of each of cement mortars M322 to M323 with the addition of the amphoteric composite hydrogel containing silica fume is also higher than that of cement mortar M3 of the amphoteric hydrogel without the addition of the silica fume. The compressive strength of the samples M332 to M333 of the amphoteric composite hydrogel containing fly ash on Days 3, 7 and 28 is higher than that of sample MO without the addition of hydrogel. The compressive strength of cement mortars M332 to M333 of the amphoteric composite hydrogel with the addition of the fly ash is higher than that of cement mortar M3 without the addition of fly ash.

Based on FIG. 6 and FIG. 7, the cement mortar added with the amphoteric composite hydrogel/pozzolanic material has higher compressive strength than the cement mortar free of hydrogel and the cement mortar added with the amphoteric hydrogel.

### Test Example 6: Drying Shrinkage of Cement Mortar

According to the ASTM C596 standard, the cement mortar sample of the Preparation example 1 was filled into a mold of 28.5×2.5×2.5 cm³. After being tamped and smoothed with a spatula, it was placed in a constant temperature and humidity chamber (25° C., 50 RH %). After 1 day, the mold was removed, and the amount of change in the length of the next day of the mortar sample was measured, that is, the amount of drying shrinkage.

FIG. 8 shows the effect of the type of amphoteric composite hydrogel containing slag on the drying shrinkage of cement mortar. The results show that the drying shrinkage of the test increases as the curing time increases. Since the hydrogel can release water, the amphoteric composite hydrogel added with the slag is more effective in controlling the release of water in the gel than the amphoteric hydrogel without slag, so cement mortars M311 to M313 have lower shrinkage amounts than the cement mortar M3. Cement mortar M3 added with the amphoteric hydrogel has a lower shrinkage amount than cement mortar MO without the hydrogel. Therefore, the addition of the amphoteric composite hydrogel/pozzolanic material can reduce the drying shrinkage of the cement mortar.

### Test Example 7: Autogenous Shrinkage of Cement Mortar

With reference to the ASTM C1698 standard measurement method, the cement mortar sample of the above Preparation example 1 was filled into a plastic tube having a diameter of 2.5 cm and a length of 8.5 cm. After being tamped and smoothed with a spatula, both ends of the tube were covered with a plastic wrap to avoid the loss of water. The cement mortar sample was placed in a constant temperature and humidity chamber (temperature: 23±2° C., humidity: 95±5%), and the mold was removed after 1 day. The next day of the mortar sample was measured for the amount of change in length, that is, the amount of autogenous shrinkage.

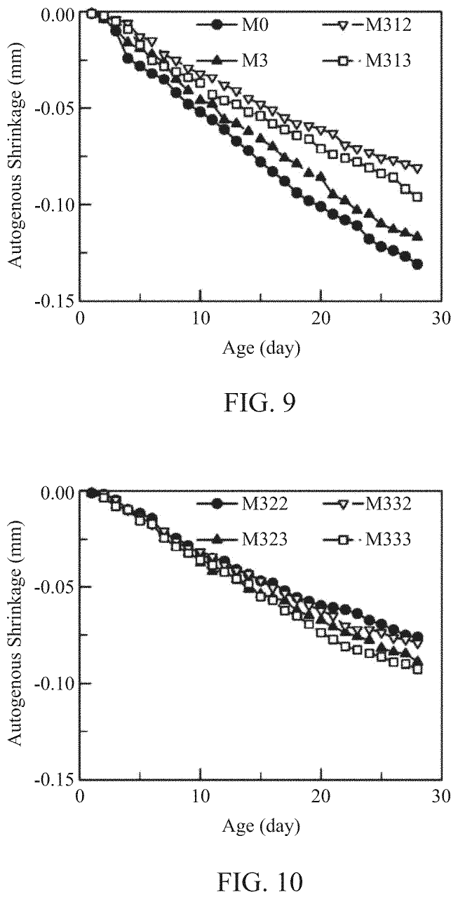

FIG. 9 shows the effect of the type of amphoteric composite hydrogel containing slag on the autogenous shrinkage of cement mortar. The results show that the amount of autogenous shrinkage of the test body increases as the curing time increases. Since the hydrogel can release water, the amphoteric composite hydrogel added with the slag is more effective in controlling the release of water from the gel than the amphoteric hydrogel without the slag. As a result, the autogenous shrinkage of each the cement mortars M312 and M313 is lower than that of cement mortar M3, and the autogenous shrinkage of the cement mortar M3 added with amphoteric hydrogel is lower than the cement mortar MO free of hydrogel.

FIG. 10 shows the effect of the amphoteric composite hydrogel type containing silica fume or fly ash on the autogenous shrinkage of cement mortar. From the results in FIGS. 9 and 10, it is found that the amount of autogenous shrinkage of the sample increases with the increasing curing time. Since the hydrogel can release water, the amphoteric composite hydrogel added with silica fume is more effective in controlling the release of water from the gel than the amphoteric hydrogel free of silica fume, so that the autogenous shrinkage of each of the cement mortars M322-M323 is lower than that of the cement mortar M3; the amphoteric composite hydrogel added with fly ash is more effective than the amphoteric hydrogel free of fly ash to control the release of water from the gel. The autogenous shrinkage of each of the cement mortars M332-M333 is lower than that of cement mortar M3.

It can be seen from FIG. 9 and FIG. 10 that the addition of the amphoteric composite hydrogel/pozzolanic material can reduce the autogenous shrinkage of the cement mortar.

### Test Example 8: Differential Scanning Thermal Analysis on Cement Paste

The cement paste of the above Preparation example 2 was placed in a constant temperature and humidity chamber (25° C., 50 RH %). After being taken out on Days 3, 7 and 28, it was placed in methanol to stop the hydration reaction, and then was dried and ground into cement paste powders. An appropriate amount of the cement paste powder was placed in an aluminum crucible, and its DSC diagram was obtained by a thermal differential scanning calorimetry (METTLER TOLEDO DSC822e). The conditions for sample determination were as follows: temperature increase at 10° C./min, temperature range of 50 to 200° C., while nitrogen gas was introduced at a flow rate of 80 mL/min.

When the cement is exposed to water, both C₃S and C₂S in the cement react with water to produce a CSH gel. In addition, the pozzolanic material and calcium hydroxide (CH) are also subject to the pozzolanic reaction to produce the CSH gel. Generally, the higher the CSH content in the cement paste test sample is, the greater the strength of the cement mortar test sample or the concrete test sample is.

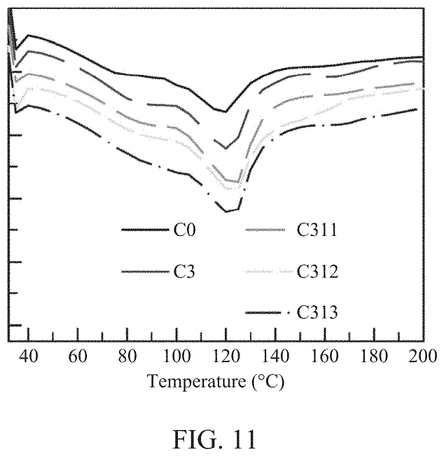

FIG. 11 is a DSC diagram of cement paste powder free of hydrogel and cement paste powder of amphoteric composite hydrogel containing different slag proportions on Day 28. Based on the figure, the lines from top to bottom are CO, C3, C311, C312 and C313, respectively. The endothermic peaks at 105 to 190° C. in FIG. 11 are generated by thermal decomposition of CSH. The larger the area of an endothermic peak is, the higher the CSH content and the strength of the sample are. As shown in the figure, the CSH content of the cement paste C3 containing the amphoteric hydrogel is higher than that of cement paste CO free of the hydrogel; the CSH contained in the cement pastes C311 to C313 of the amphoteric composite hydrogel containing slag is higher than that of cement paste C3 of the amphoteric hydrogel without slag. Therefore, the cement mortar added with the amphoteric composite hydrogel/pozzolanic material has higher compressive strength than the cement mortar free of hydrogel and the cement mortar added with the amphoteric hydrogel.

The above embodiments merely serve as illustration, and are not intended to limit the present disclosure. Modifications and variations of the above-described embodiments can be made by a person skilled in the art without departing from the spirit and scope of the present disclosure. Therefore, the scope of the disclosure is defined by the scope of the appended claims. As long as the effects and implementation purposes of the present disclosure are not affected, they should be encompassed by the present technical disclosure.

What is claimed is:

1. An amphoteric composite hydrogel, comprising:
a polymer having a structure of formula I, 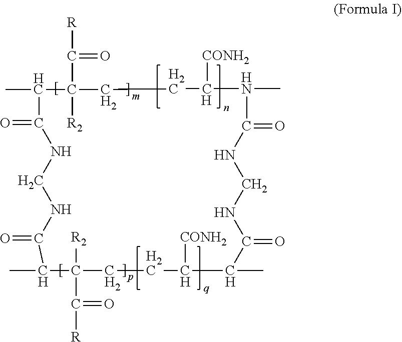
wherein m, n, p and q are each an integer of 0 to 1000, m+n>100, p+q>100, R is 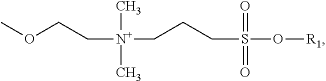
R₁ is H or an alkali metal element, and R₂ is H or CH₃; and
a pozzolanic material incorporated into the polymer having the structure of formula I.

2. The amphoteric composite hydrogel of claim 1, wherein the pozzolanic material is at least one selected from the group consisting of slag, fly ash, silica fume, rice husk ash, kaolin, montmorillonite and diatomite.

3. The amphoteric composite hydrogel of claim 2, wherein the pozzolanic material is at least one selected from the group consisting of slag, fly ash and silica fume.

4. The amphoteric composite hydrogel of claim 1, wherein the pozzolanic material has an amount of 0.1 wt % to 40 wt % based on the polymer.

5. The amphoteric composite hydrogel of claim 1, wherein the pozzolanic material has an amount of 5 wt % to 20 wt % based on the polymer.

6. The amphoteric composite hydrogel of claim 1, being used as a curing agent for a concrete composition to maintain humidity in a concrete or cement mortar.

7. The amphoteric composite hydrogel of claim 1, being solid powder having a particle size of 0.05 mm to 0.25 mm.

8. A cement mortar composition, comprising:
a mortar mix; and
the amphoteric composite hydrogel of claim 1.

9. The cement mortar composition of claim 8, wherein the mortar mix comprises water, cement, fine aggregates having a particle size of 150 μm to 4.75 mm and a dispersant.

10. The cement mortar composition of claim 9, wherein the amphoteric composite hydrogel has an amount of 0.1 wt % to 0.5 wt % based on the cement.

11. The cement mortar composition of claim 9, wherein the dispersant is an anionic dispersant.

12. A concrete composition, comprising:
a concrete mix, and
the amphoteric composite hydrogel of claim 1.

13. The concrete composition of claim 12, wherein the concrete mix comprises water, cement, fine aggregates having a particle size of 150 μm to 4.75 mm, and coarse aggregates having a particle size of more than 4.75 mm.

14. The concrete composition of claim 13, wherein the amphoteric composite hydrogel has an amount of 0.1 wt % to 0.5 wt % based on the cement.
